(19) United States
(12) Patent Application Publication
(10) Pub. No.: US 2025/0120332 A1
(43) Pub. Date: Apr. 17, 2025

(54) Automated Systems And Methods For Treating Seeds

(71) Applicant: MONSANTO TECHNOLOGY LLC, St. Louis, MO (US)

(72) Inventors: Adam Vernon CUMMINGS, Carver, MN (US); Mark William OTTESON, Burnsville, MN (US); Greg Allen REINECCIUS, Chanhassen, MN (US); Kwan Y. THAI, O'Fallon, MO (US)

(21) Appl. No.: 18/916,207

(22) Filed: Oct. 15, 2024

Related U.S. Application Data
(60) Provisional application No. 63/544,420, filed on Oct. 16, 2023.

(51) Int. Cl. A01C 1/06; B05C 11/10; B05C 11/11

(52) U.S. Cl. CPC A01C 1/06; B05C 11/1013; B05C 11/1026; B05C 11/11

(57) ABSTRACT

Systems and methods are provided for use in treating seeds. In one example embodiment, such a system includes a keg assembly including a seed treatment and a seed treater in fluid communication with the keg assembly via a supply line. The seed treater includes an application chamber configured to receive the seed treatment from the keg assembly via the supply line and apply the seed treatment to seeds. The system also includes a priming assembly coupled to the supply line and configured to automatically prime the supply line with the seed treatment, and a seed metering chamber configured to deliver an amount of the seeds to the application chamber based at least in part on a weight of the seeds received in the seed metering chamber.

### CROSS-REFERENCE TO RELATED APPLICATION

This application claims the benefit of, and priority to, U.S. Provisional Application No. 63/544,420, filed on Oct. 16, 2023. The entire disclosure of the above-referenced application is incorporated herein by reference.

### FIELD

The present disclosure generally relates to automated systems and methods for use in treating seeds.

### BACKGROUND

This section provides background information related to the present disclosure which is not necessarily prior art.

Seeds are often coated or treated with one or more active ingredients, such as biological or chemical agents, prior to planting to enhance the seeds (e.g., improve viability, improve longevity, provide protection, etc.). The treatments may serve to attack target bacteria, molds, or fungus that may potentially contaminate the seeds or that may be present in the soil in which the seeds are planted. The treatments may also, or alternatively, include insecticides or pesticides, and may serve to provide deterrence from or prevention of damage caused by insects and other animal pests that target the seeds. Further, the treatments may include fertilizer to help facilitate growth of the seeds when planted. In connection therewith, seed treatment devices may be used to coat/treat the seeds with the seed treatments.

### SUMMARY

This section provides a general summary of the disclosure, and is not a comprehensive disclosure of its full scope or all of its features.

Example embodiments of the present disclosure generally relate to automated seed treatment system for use in treating seeds with one or more treatment(s). In one example embodiment, such a system generally includes a keg assembly including a seed treatment; a seed treater in fluid communication with the keg assembly via a supply line, the seed treater configured to receive the seed treatment from the keg assembly via the supply line and apply the seed treatment to seeds; and a priming assembly coupled to the supply line, the priming assembly configured to automatically prime the supply line with the seed treatment.

In another example embodiment, an automated seed treatment system generally includes a keg assembly including a seed treatment; an application chamber in fluid communication with the keg assembly, the application chamber configured to apply the seed treatment to seeds; and a seed metering chamber configured to deliver an amount of the seeds to the application chamber based at least in part on a weight of the seeds received in the seed metering chamber.

In another example embodiment, an automated seed treatment system generally includes a keg assembly including a seed treatment; a seed treater in fluid communication with the keg assembly via a supply line, the seed treater including an application chamber configured to receive the seed treatment from the keg assembly via the supply line and apply the seed treatment to seeds; a priming assembly coupled to the supply line, the priming assembly configured to automatically prime the supply line with the seed treatment; and a seed metering chamber configured to deliver an amount of the seeds to the application chamber based at least in part on a weight of the seeds received in the seed metering chamber.

Example embodiments of the present disclosure also generally relate to automated methods for use in treating seeds with one or more treatment(s). In one example embodiment, such a method generally includes priming a treatment supply line extending between a keg assembly and a seed treater with a seed treatment; and then delivering an amount of the seed treatment to the seed treater via the primed supply line based on an amount of seeds in the seed treater and/or delivering an amount of seeds to the seed treater based on an amount of the treatment delivered to the seed treater via the primed supply line.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example seed treatment system of the present disclosure;

FIG. 2 is a perspective view of an example keg assembly of the seed treatment system of FIG. 1;

FIG. 3 is a perspective view of an example priming assembly of the seed treatment system of FIG. 1;

FIG. 4 is a perspective view of an example sensor of the priming assembly of FIG. 3;

FIG. 5 is an exploded perspective view of the priming assembly of FIG. 3;

FIG. 6 is a perspective view of an example seed treater of the seed treatment system of FIG. 1;

FIG. 7 is a side elevation view of the seed treater of FIG. 6;

FIG. 8 is a perspective view of the seed treater of FIG. 6, with a drum of the seed treater removed;

FIG. 9 is a fragmentary perspective view of an example seed metering chamber of the seed treater of FIG. 6;

FIG. 10 is a perspective of an example seed wheel of the seed metering chamber of FIG. 9; and

FIG. 11 is an example computing device that may be used in the seed treatment system of FIG. 1.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

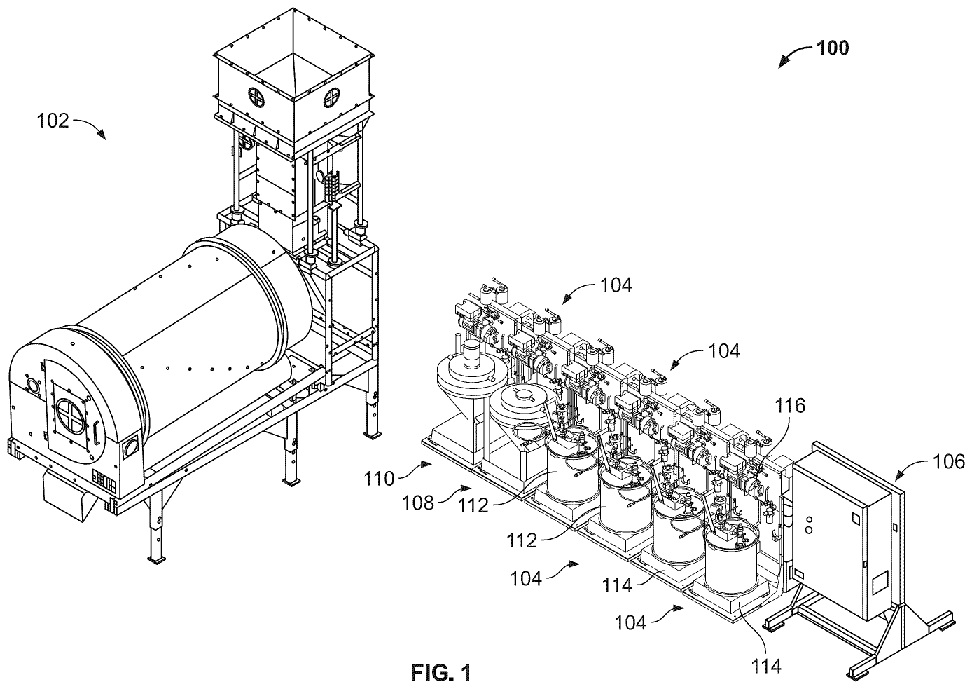

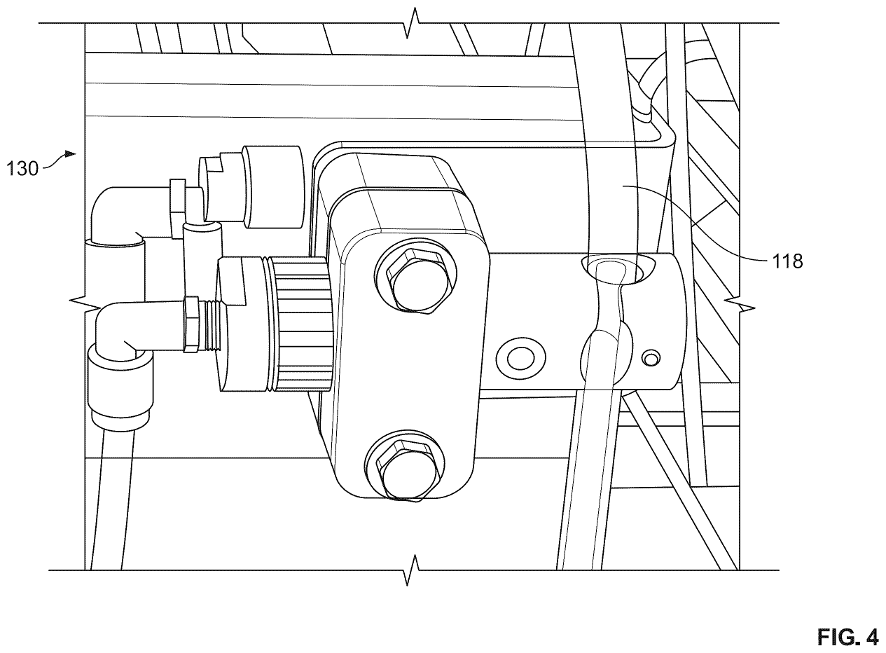

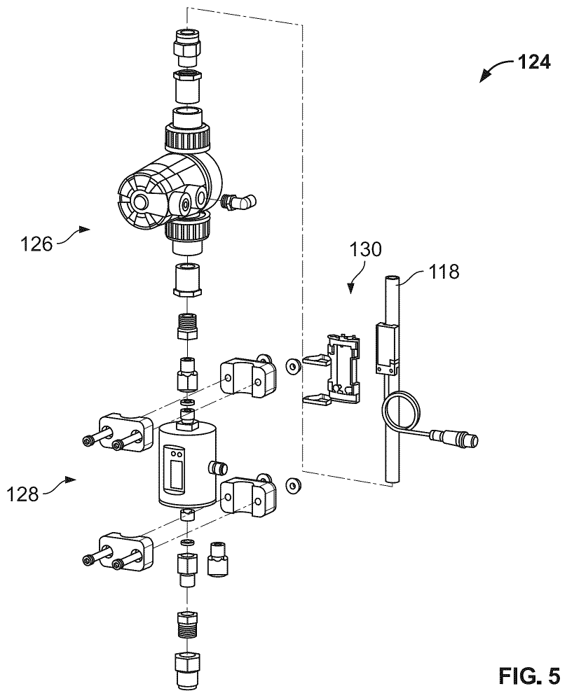

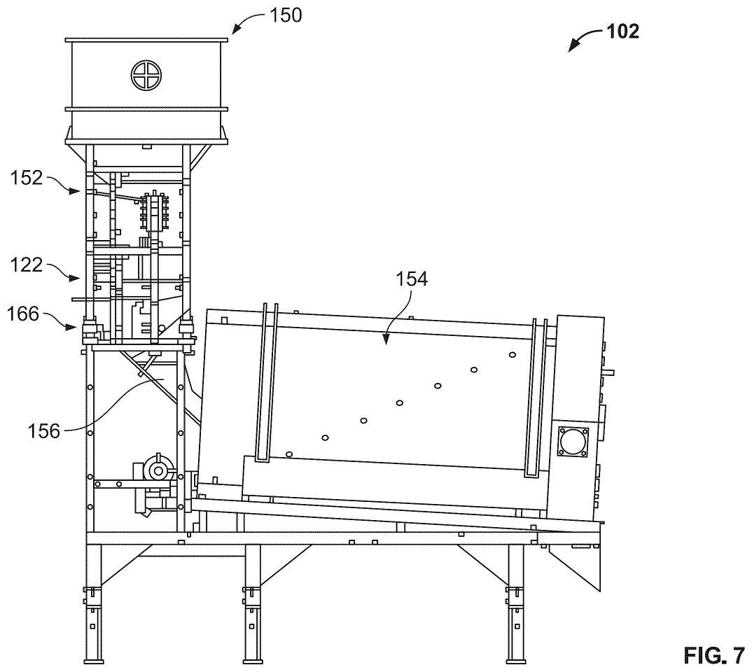

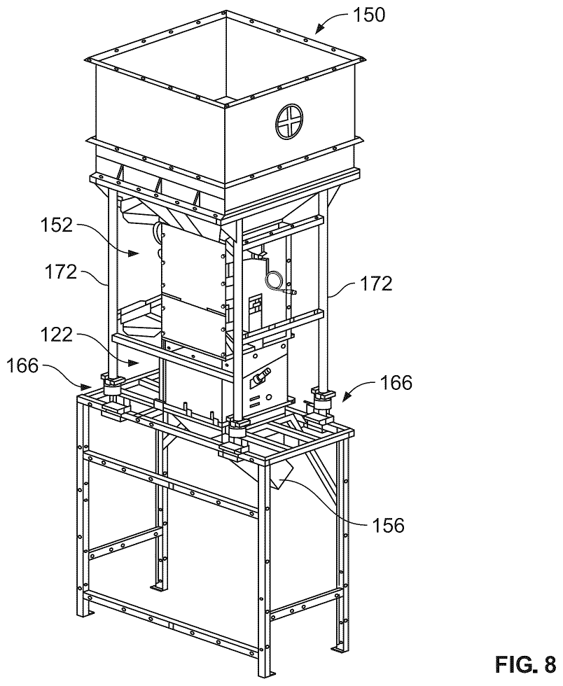

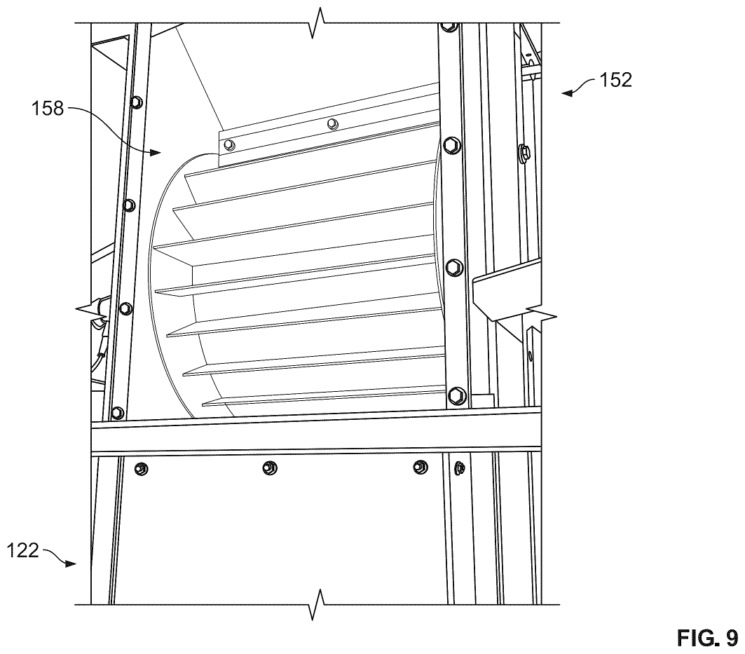

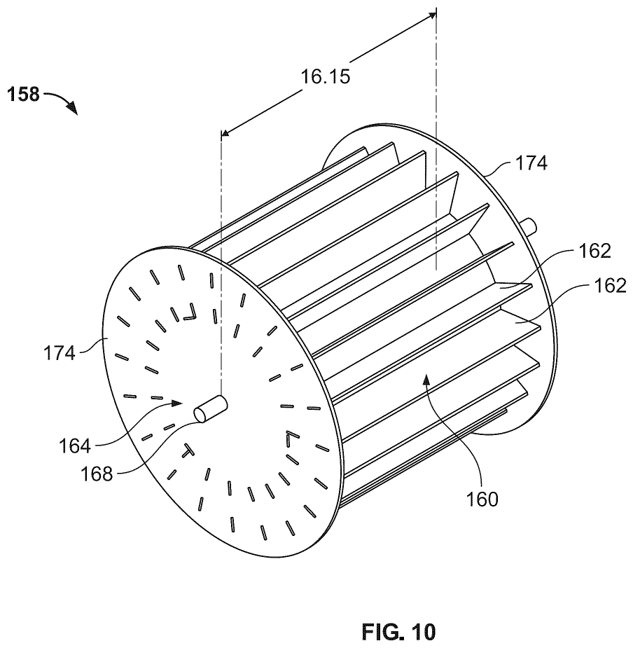

FIGS. 1-10 illustrate an example embodiment of an automated seed treatment system 100 including one or more aspects of the present disclosure. As will be described, the seed treatment system 100 is configured to automatically meter a desired amount of seeds for treatment and then automatically provide a desired type and/or amount of treatment(s) to coat/treat the seeds, prior to the seeds being planted, to enhance growing of the seeds (e.g., improve viability, improve longevity, provide protection, etc.). In this manner, the seed treatment system 100 is configured to both provide a desired amount of seeds for treatment and a desired amount of treatment for the give seeds, thereby improving efficiency and efficacy of such seed treatment operation (e.g., as a more precise, correct, etc. amount of treatment is provided to the seeds with less waste; etc.).

As shown in FIG. 1, the system 100 generally includes a seed treater 102 (e.g., a seed treatment unit, etc.) for metering (e.g., automatically, etc.) a desired amount of seeds for treatment, and multiple keg stations (e.g., treatment containment stations, etc.), each indicated 104, in fluid communication with the seed treater 102 for delivering (e.g., automatically, etc.) a desired amount(s) of treatment(s) to the seeds at the seed treater 102. As described in more detail hereinafter, the system 100 may operate to provide the desired amount of treatment (from the keg stations 104) to the seed treater 102 based on the metered amount of seeds provided by the seed treater 102. Or, alternatively, the system 100 may operate to meter the desired amount of seeds at the seed treater 102 based on the amount of treatment available at, or being delivered to, the seed treater 102 by the keg stations 104 to the seed treater. In either case, the system 100 operates to automatically provide the desired amount of treatment to the desired amount of seeds to achieve the efficiency and/or efficacy of such seed treatment noted above.

That said, the keg stations 104 of the system 100 are each configured to hold desired seed treatment(s) for coating/treating seeds in the seed treater 102. In connection therewith, a desired amount seeds to be treated by the system 100 are positioned (e.g., metered, etc.) within the seed treater 102, and the keg stations 104 are configured to deliver the seed treatment(s) (in the desired amount(s)) to the seed treater 102 for application to the seeds. A computing device 106 coupled in communication with the seed treater 102 and the keg stations 104 is configured to control such operation of the seed treater 102 and keg stations 104 to effect desired treatment of the seeds. In particular, the computing device 106 is configured to generally match the amount of treatment needed (or desired) for the given amount of seeds received (or metered) in the seed treater 102, and/or match the amount of seeds needed (or to be metered by the seed treater 102) based on the amount of treatment available and/or received from the keg stations 104 at the seed treater 102.

In the illustrated embodiment, the system 100 includes ten keg stations 104 each configured hold a desired treatment(s). However, in other example embodiments, the system 100 may include more than ten keg stations 104 or fewer than ten keg stations 104. In addition, the treatment(s) included in the keg stations 104, and applied to the seeds at the seed treater 102, may include one or more fluid treatments, slurry treatments, etc. In addition, the treatment(s) may include any desired or suitable treatment(s) or formulation(s) for application to the seeds, for example, biological agents and/or agrochemicals, seed-finishing agents for enhancing one or more physical properties of the exterior surfaces of the seeds, pesticidal agents (e.g., chemical pesticides, biopesticides or biocontrol agents, etc.), chemical herbicides, biopesticidal agents the presence and/or output of which is toxic to at least one plant (e.g., weeds, etc.), biostimulants and/or microbial inoculants, beneficial microbes, nutrients (e.g., nitrogen, phosphorous, potassium, etc.), water, etc.

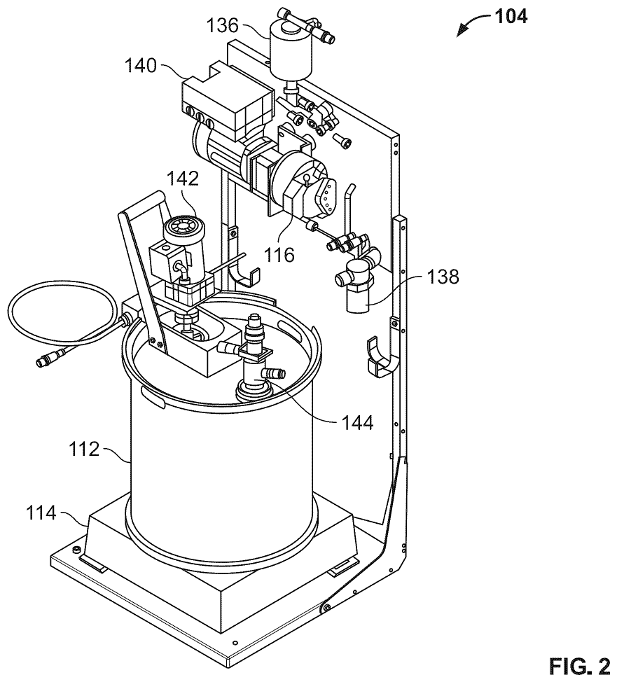

In the illustrated embodiment, the system 100 also includes a flex-tank station 108 and an agitator station 110 in fluid communication between the keg stations 104 and the seed treater 102. The flex-tank station 108 may include a water source (or reservoir) for adding water to treatment(s) (from the keg stations 104) that require dilution, or it may include a solid or powered component, such as an inoculant, that may be mixed with water and then added to or included with the treatment(s). And, the agitator station 110 is configured to agitate or mix the treatment(s) as needed (e.g., in addition to stirrer units 142 included at the keg stations 104 (see, FIG. 2), where such agitation or mixing is not available in the keg stations 104, the flex-tank station 108, etc.), prior to delivery of the treatment(s) to the seed treater 102. That said, it should be appreciated that the flex-tank station 108 and/or the agitator station 110 may not be included (or may not be required) in all embodiments of the present disclosure.

Referring now to FIG. 2, one of the keg stations 104 of the system 100 is illustrated. As shown, the keg station 104 generally includes a container 112 configured to hold a desired treatment, and a scale 114 (e.g., a load cell with a motion sensor, etc.) supporting the container 112 (e.g., disposed on a base of the keg station 104, etc.). In connection therewith, the scale 114 is configured to provide, for example, continuous or periodic measurement of a weight of the container 112, and any changes in the weight of the container 112 indicative of a change in the volume of treatment stored in the container 112, for example, to the computing device 106 (via controller 140 (e.g., coupled to or mounted to a back mount of the keg station 104, etc.)). In this way, the scale 114 operates to provide weight data (and, thus, volume data) to the computing device 106, indicating an amount of treatment that is actually being applied or delivered by the keg station 104 to a quantity of seed in the seed treater 102 (e.g., to help facilitate matching the amount of treatment being delivered to the seed treater 102 to the metered seeds within the seed treater 102, etc.).

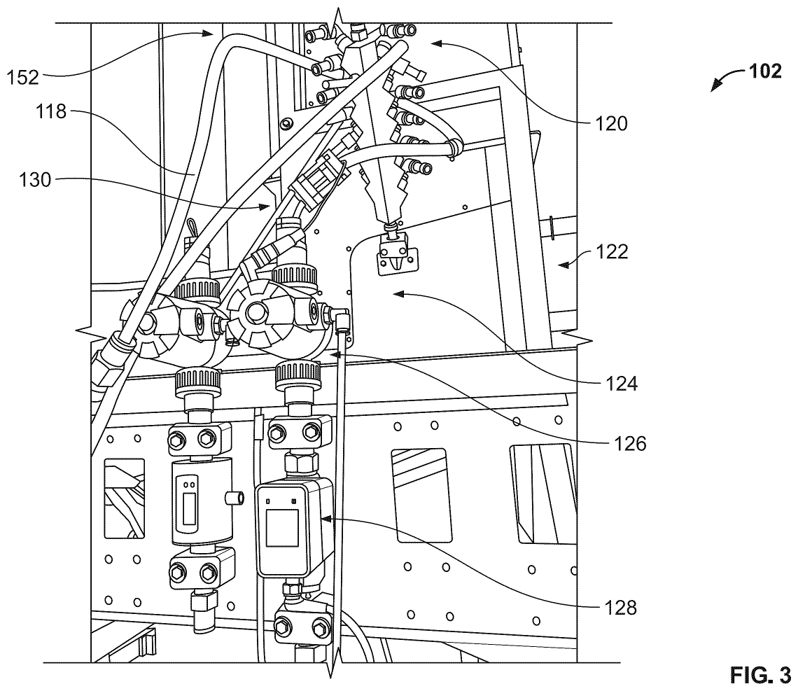

The keg station 104 also includes a pump 116 (e.g., coupled to or mounted to a back mount of the keg station 104, etc.) configured to direct the treatment (e.g., a desired amount of the treatment, a desired flow rate of the treatment, etc.) from the container 112 of the keg station 104 to the seed treater 102 (e.g., through the flex-tank station 108 and the agitator station 110 when included in the system 100, etc.). A fluid supply line 118 (see, FIGS. 3-5) extends between the keg station 104 (e.g., as coupled to the container 112 at coupler 144, etc.) and a manifold 120 of the seed treater 102. The pump 116, then, is configured to transfer (e.g., move, etc.) specific amounts of treatment from the container 112 of the keg station 104, through the supply line 118, and to the manifold 120 of the seed treater 102 for use in delivering the treatment into an application chamber 122 thereof (e.g., based on a metered amount of seeds received into the application chamber 122 of the seed treater 102, or not; etc.). In doing so, in the illustrated embodiment, the treatment also passes through an air removal valve 136 (e.g., coupled to or mounted to a back mount of the keg station 104, etc.), to remove any air introduced into the supply line, prior to delivery of the treatment to the manifold 120. In addition, as the treatment is pumped out of the container 106, the treatment may also pass through a filter 138 configured to remove particulate matter from the treatment prior to entering the pump 108. The pump 108 then directs the fluid through the air-removal valve 144 (and through flex-tank station 108 and the agitator station 110 when included in the system 100) and on to the seed treater 102.

That said, the pump 116 of the keg station 104 may include any suitable pump within the scope of the present disclosure, for example, a variable flow pump, a peristaltic pump, a roller pump, a high-volume fluid pump, or other positive displacement pump, etc. In addition, the container 112 of the keg station 104 may include any suitable container having any desired size within the scope of the present disclosure (and thus having any desired capacity). For example, the container 112 of the keg station 104 may have a size/capacity of between about five gallons and about fifty gallons (e.g., about fifteen gallons, about thirty gallons, etc.), or more or less.

It should be appreciated that the above description of the keg station 104, as illustrated in FIG. 2, also applies to the other ones of the keg stations 104 of the system 100.

It should also be appreciated that the supply lines 118 extending between the keg stations 104 and the seed treater 102 may vary in length, for example, depending on sizes of locations and/or facilities in which the system 100 is installed, positions of the keg stations 104 relative to the seed treater 102 in a facility, routes extending between the keg stations 104 and the seed treater 102, etc. In some example embodiments, the supply lines 118 may extend in length upwards of fifty feet or more.

In connection therewith, in the illustrated embodiment, each of the keg stations 104 of the system 100 is associated with a priming assembly 124 configured to prime (or re-prime) the corresponding supply line 118 generally automatically with treatment from the corresponding keg station 104 (e.g., up to the manifold 120 of the application chamber 122 of the seed treater 102, etc.). In general, in priming the supply lines 118, the system 100 (via the priming assemblies 124) is configured to fill the supply lines 118 from the keg assemblies to the seed treater, to a generally tipping point (or filled point) at the manifold 120, to assure (or ensure) that the treatment(s) being pumped and measured from the keg stations 104 is/are readily available (e.g., continuously available, etc.) and precisely applied to the seeds (and not merely filling random length sections of the supply lines 118 as may be the case if the supply lines 118 are not primed or are not completely primed). In this manner, in some example embodiments (based on the primed condition of the supply lines 118), particular amounts of treatment may be generally immediately delivered to the application chamber 122 of the seed treater 102, for example, based on a metered amount of seeds within the application chamber 122, whereby the priming assembly 124 works in conjunction with the seed treater 102 to generally match, automatically, the delivered amount of treatment to the application chamber 122 with the metered amount of seeds in the application chamber 122. The priming assemblies 124 herein may be operated by the system 100 (e.g., by the computing device 106, etc.) together (whereby all of the supply lines 118 may be primed at once), or individually (whereby select ones (or select combinations) (but less than all) of the supply lines 118 are primed together) to generally provided for such automatic delivery of the treatments to the application chamber 122 of the seed treater 102 from all keg stations 104.

With additional reference to FIGS. 3-5, each priming assembly 124 (as associated with each of the keg stations 104 (e.g., whereby each keg station 104 is associated with a dedicated priming assembly 124, etc.)) generally includes a valve unit 126 (e.g., a pneumatic valve unit, etc.), a flow meter 128 coupled with the valve unit 126, and a sensor 130 (e.g., a capacitive sensor, etc.). As shown, the valve unit 126 and the flow meter 128 (generally combined as a flow control module of the priming assembly 124) are coupled in communication with the supply line 118 of the keg station 104 associated with the given priming assembly 124. In particular, as shown, the valve unit 126 and the flow meter are coupled to the supply line 118 at a location generally adjacent to the manifold 120 of the seed treater 102. And, the sensor 130 is then coupled to the supply line 118 generally between the valve unit 126 and flow meter 128 and the manifold 120.

The sensor 130 is configured to measure presence of treatment within a center portion of the supply line 118 generally at the tipping point of the supply line 118 (e.g., at a location where the supply line is leading into the manifold 120, etc.). In connection therewith, the sensor 130 may be trained to determine the presence of the treatment within the supply line 118 (e.g., at a particular depth within the line 118, etc.). For instance, the sensor 130 may be trained to determine the presence of the treatment within the supply line 118, at a particular depth (e.g., a range of X mm to X cm, etc.), based on a training input that chemical is in the line, or not, at the depth. The trained sensor 130, then, is configured to subsequently read the chemical in the line and determine if the line is full or empty (and thereby provide an indication as to whether chemical should be pushed into or pulled from the line 118).

During general operation of the keg stations 104 in the system 100, the pumps 116 operate (via the computing device 106, etc.) to move treatment(s) from the containers 112, through the corresponding supply lines 118, and to the manifold 120 of the seed treater 102. The manifold 120, then, delivers the treatment(s) into the application chamber 122 of the seed treater 102 for application to the seeds (e.g., in a desired amount whereby the seed treater 102 then operates to meter a particular amount of seeds to match the amount of treatment(s) received from the deg stations 104, and/or in a desired amount to match a metered amount of seeds at the seed treater 102, etc.). Once the desired amount of treatment(s) is delivered to the manifold 120 (and application chamber 122), the pumps 116 are stopped and flow of the treatment(s) through the supply lines 118 ceases. In doing so, though, conventionally the treatment(s) may still continue to flow through the corresponding supply lines 118 even after the pumps 116 stop. Uniquely herein, for each of the keg stations 104, the priming assembly 124 associated with the keg station 104 is configured to detect presence of treatment in the supply line 118 of the keg station 104 (via the sensor 130), in advance of (or prior to) the stopping point for priming (e.g., just prior to the manifold 120 of the seed treater 102, generally at the manifold 120 of the seed treater 102, etc.). The flow meter 128 of the priming assembly 124, then, is configured to measure (again, near the stopping point (e.g., adjacent the manifold 120 of the seed treater 102 and prior to the sensor 130, etc.)) a small amount of treatment to continue pumping (e.g., so as to completely prime the supply line 118, etc.) and close the valve unit 126 to stop the excess flow of treatment typically present when operation of the pump 116 is stopped (and provide for and/or maintain a generally completely primed supply line 118). And, the pump 116 at the corresponding keg station 104 is turned off (or stopped).

That said, the priming assemblies 124 described herein may be used to automatically prime the supply lines 118 of the system 100 with treatment(s) in connection with various different operations of the system 100. For instance, the priming assemblies 124 may be used in connection with initially filling the supply lines 118 with treatment(s) from the keg stations 104 (e.g., in connection with an initial operation of the system 100, etc.). Additionally, or alternatively, the priming assemblies 124 may be used to top off the supply lines 118 with treatment(s), for instance, if the supply lines 118 have not run treatment for a given period of time (e.g., greater than about two hours, etc.) or when containers 112 are replaced at the keg stations 104. Further, the priming assemblies 124 may be used to reprime the supply lines 118 in instances where the pumps 116 of the keg assemblies 104 are reversed for one or more reasons (e.g., to recover or recapture treatment(s) from within the supply lines 118 back into the containers 112 of the keg assemblies 104, etc.). In any case, in this manner, the priming assemblies 124 may operate in connection with the seed treater 102 to automatically provide a desired amount of treatment(s) to the seeds at the seed treater 102, on demand based on the primed condition of the treatment(s) in the supply lines 118 (e.g., without delay, in an accurate amount, etc.), that generally corresponds to an amount of seeds at the application chamber 122 of the seed treater 102 (e.g., to provide improved efficiency in application of the treatment(s), etc.).

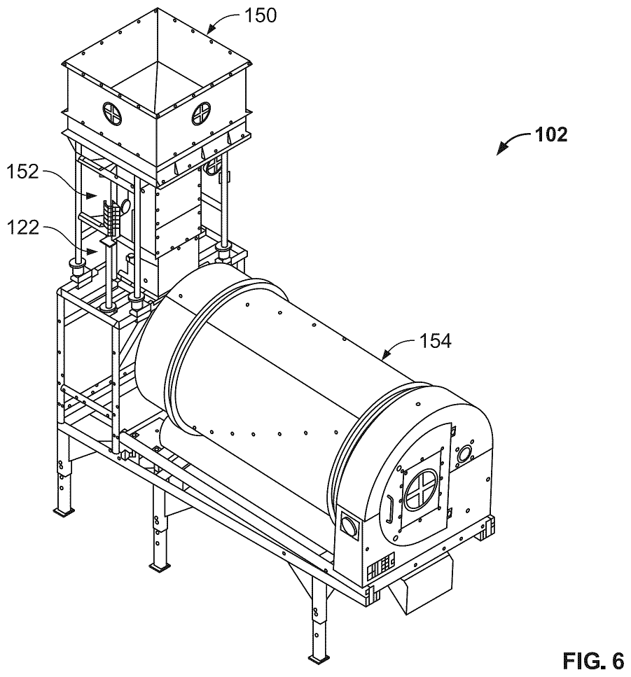

Referring now to FIGS. 6-10, the seed treater 102 of the system 100 generally includes a hopper 150, a seed metering chamber 152 disposed generally below the hopper 150, and the treatment application chamber 122 disposed generally below the seed metering chamber 152. The hopper 150 is configured to receive seeds to be treated into the seed treater 102 (e.g., manually, automatically from a conveyor, etc.) and direct the received seeds into the seed metering chamber 152. In turn, the seed metering chamber 152 is configured to meter (or portion, etc.) the received seeds and deliver a specific amount (e.g., a specific or desired number, a specific or desired volume, etc.) of seeds to the treatment application chamber 122. Treatment(s) from the keg stations 104 are then introduced to the seeds (e.g., applied to the seeds, etc.) at the application chamber 122 (via the manifold 120). In an example embodiment, the application chamber 122 may include a dispersion cone for directing (or routing) the seed within the application chamber 122 and a spinning atomizer wheel or bowl for applying the treatment(s) to the seeds. For instance, the seeds received from the seed metering chamber 152 may be funneled onto the cone where they are dispersed into an annular seed stream and sprayed with atomized treatment(s). And, the seeds and treatment(s) are directed from the application chamber 122 to the drum 154 (via chute 156) where the seeds and treatment(s) are mixed (e.g., rotated, etc.) together for a desired period of time to effect coating (or treating) of the seeds with the treatment(s). The coated and/or treated seeds may then be removed from the drum 154, for example, via an outlet, and packaged in a container (e.g., a bag, a truck bed, etc.) for delivery to a customer, etc. for subsequent planting.

In the illustrated embodiment, the seed metering chamber 152 of the seed treater 102 includes a unique seed wheel 158 configured to calibrate (generally automatically and/or in an automated manner) a weight and/or volume of seeds received into the hopper 150, and deliver specific (or desired) amounts of the seeds to the application chamber 122. The seed wheel 158 is also configured to accommodate different sizes of seeds received into the hopper 150 for treatment. In this way, the seed wheel 158 provides for improved accuracy in application of the treatment(s) to the seeds at the application chamber 122. In connection therewith, as generally described above, the specific amount of seeds delivered to the treatment application chamber 122 by the seed wheel 158 of the seed metering chamber 152 may be based an amount of treatment(s) being delivered to the treatment application chamber 122 by the keg stations 104. Or, alternatively, the amount of treatment(s) delivered to the treatment application chamber 122 by the keg stations 104 may be based on the amount of seed delivered to the treatment application chamber 122 by the seed wheel 158 of the seed metering chamber 152.

In particular in the illustrated embodiment, the seed wheel 158 defines multiple pockets 160 configured to receive seeds. The pockets 160 are formed by (or between) veins 162 (or platforms, or surfaces, etc.) extending generally radially outward (and way) from a central hub 164 (or body) of the seed wheel 158, and generally between end walls 174 of the seed wheel 158. The multiple pockets 160 then extend circumferentially around the seed wheel 158 (and the central hub 158). And, each of the pockets 160 defines a particular volume whereby the pocket 160 is configured (e.g., sized, shaped, etc.) to receive and/or hold a particular number, volume, etc. of seeds. In the illustrated embodiment, the seed wheel 158 includes twenty pockets 160 extending generally circumferentially around the seed wheel 158. It should be appreciated, though, that the seed wheel 158 may include a different number of pockets in other example embodiments (e.g., ten pockets, sixteen pockets, thirty pockets, more than thirty pockets, etc.).

That said, in an example operation of the seed treater 102, the seeds are received into the hopper 150 and flow to the seed wheel 158. In connection therewith, the seed wheel 158 rotates within the seed metering chamber 156 (via axle 168 as driven by a suitable motor, etc.) and receives (and collects) the seeds from the hopper 150 within the pockets 160 of the seed wheel 158 (e.g., within generally upward facing pockets 160, etc.). In this way, each of the pockets 160 of the seed wheel 158 receives and/or is filled with a particular volume of seeds from the hopper 150. At the same time (or substantially the same time), load cells 166 of the seed treater 102, coupled to the hopper 150 (e.g., at lower portions of legs 172 such that (without limitation) four load cells 166 are included in the illustrated embodiment, etc.), are configured to measure a weight of the seeds received in the hopper 150 (and in the seed metering chamber 156). And, as the seed wheel 158 rotates, the seeds collected within the pockets 160 are rotated and delivered (e.g., dumped, dropped, etc.) into the application chamber 122 therebelow. In this way, the seed wheel 158 is configured to measure a total volume of seeds received into the seed metering chamber 156 from the hopper 150 (e.g., based on a number of rotations of the seed wheel 158 (and/or a speed of rotation of the seed wheel 158) and thus a number of pockets 160 of the seed wheel 158 filled with seeds and transferred to the application chamber 122, etc.), and the load cells 166 are configured to measure a total weight of the same volume of seeds. The volume and weight information is then used, by the computing device 106, to calculate the amount of seed treatment(s) needed from the keg stations 104 to apply to the seeds at the application chamber 122 (for the given amount of received seeds).

Uniquely herein, the system 100 is configured for automatic calibration between the seed treatment provided by the keg stations 104 and the metered amount of seeds delivered to the treatment application chamber 122 by the seed wheel 158 of the seed metering chamber 152. In particular, in some instances, the system 100 may operate (e.g., as controlled by the computing device 106, etc.) to provide the desired amount of treatment (from the keg stations 104) to the treatment application chamber 122 of the seed treater 102, generally immediately (or on demand) via operation of the priming assemblies 124, based on the metered amount of seeds provided to the treatment application chamber by the seed wheel 158. Alternatively, in other instances, the system 100 may operate (e.g., as controlled by the computing device 106, etc.) to meter, via the seed wheel 158, delivery of the desired amount of seeds to the treatment application chamber 122 of the seed treater 102 based on the amount of treatment available at, or being delivered to, the seed treater 102 by the keg stations 104, via the priming assemblies 124. As such, through such automated calibration, the system 100 operates to automatically provide the desired amount of treatment to the desired amount of seeds to achieve the efficiency and/or efficacy of such seed treatment noted herein.

The seed treatment system 100 of the present disclosure may additionally include sensors, flow meters, and/or controls to monitor/control both the flow rates of the treatment products coming out of the pumps 116 and the metered volume of seeds entering or exiting the application chamber 122. Based upon a pre-programmed treatment(s), the computing device 106 of the system 100 can automatically (and generally immediately based on the primed condition of the supply lines 118) adjust the flow rates of the treatment(s) (via the pumps 116) based on the amount of seeds (as determined at the seed metering chamber 152) to be treated that are supplied to the application chamber 122 at a given time in order to control the amount of treatment(s) applied to the seeds. Vice-versa, again based on a pre-programmed treatment(s), the computing device 106 may automatically adjust operation of the seed wheel 158 (e.g., a rotational speed, etc.) to increase or decrease an amount of seeds delivered to the application chamber 122 at a given time, based on a flow of treatment(s) to the application chamber via the priming assemblies 124, again in order to control the amount of treatment(s) applied to the seeds. Thus, in either case, if a flow sensor sensing the flow rate of the treatment(s) products and the amount of seeds determined to have been received by the seed metering chamber 152 indicate that the ratio of flow rate to amount of seeds is not within a desired threshold and/or is not within a predetermined optimal ratio or a range of ratios, the system 100 (via the computing device 106) is configured to automatically adjust the flow rate of seeds (via the seed wheel 158) and/or the volume of chemical treatment product being delivered (via the keg assemblies 104 and/or priming assemblies 124).

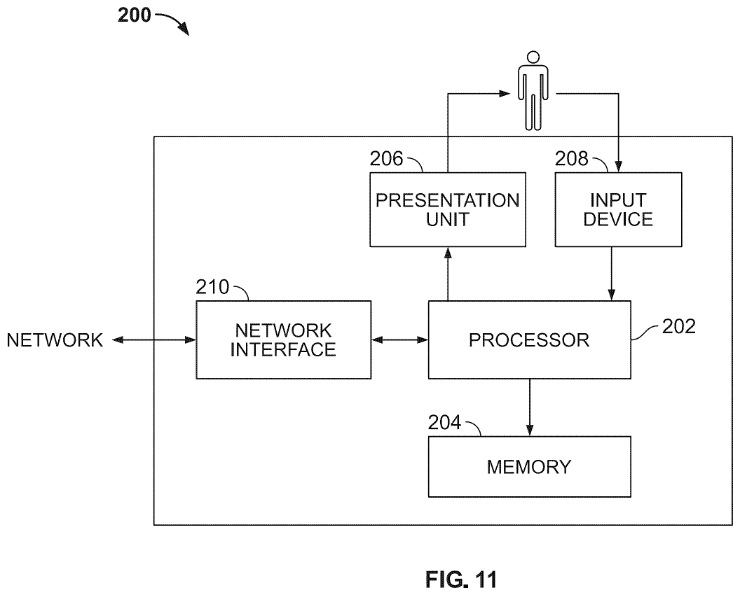

FIG. 11 illustrates an example computing device 200 that can be used in connection with the seed treatment system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the example embodiment herein, the computing device 106 may be considered as including and/or being implemented in at least one computing device consistent with computing device 200. However, the present disclosure should not be considered to be limited to the computing device 200, as described below, as different computing devices and/or arrangements of computing devices and/or arrangement of components associated with such computing devices may be used.

Referring to FIG. 11, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, treatment recipes, formulation information for various chemical treatment formulations, the various data (and/or corresponding data structures) described herein, etc. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiency and/or performance of the processor 202 and/or other computer system components configured to perform one or more of the various operations herein. It should be appreciated that the memory 204 may include a variety of different memories, each implemented in one or more of the functions or processes described herein.

The computing device 200 also includes a presentation unit 206 that is coupled to (and is in communication with) the processor 202 (however, it should be appreciated that the computing device 200 could include output devices other than the presentation unit 206, etc.). The presentation unit 206 outputs information to users of the computing device 200 as desired. And, various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the users of the computing device 200. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both a presentation unit and an input device.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks. Further, in some example embodiments, the computing device 200 may include the processor 202 and one or more network interfaces incorporated into or with the processor 202.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A seed treatment system for use in treating seeds with one or more treatment(s), the seed treatment system comprising:
a keg assembly including a seed treatment;
a seed treater in fluid communication with the keg assembly via a supply line, the seed treater configured to receive the seed treatment from the keg assembly via the supply line and apply the seed treatment to seeds; and
a priming assembly coupled to the supply line, the priming assembly configured to automatically prime the supply line with the seed treatment.

2. The seed treatment system of claim 1, wherein the priming assembly includes a flow control module coupled to the supply line at a first location along the supply line, and a sensor coupled to the supply line at a second location along the supply line.

3. The seed treatment system of claim 2, wherein the flow control module includes a valve unit and a flow meter.

4. The seed treatment system of claim 2, further comprising a manifold positioned adjacent the seed treater, wherein the supply line is coupled to the manifold, and wherein the manifold is configured to receive the seed treatment from the keg assembly through the supply line and deliver the seed treatment to the seed treater.

5. The seed treatment system of claim 4, wherein the priming assembly is coupled to the supply line adjacent the manifold.

6. The seed treatment system of claim 5, wherein the sensor of the priming assembly is coupled to the supply line at a location generally between the flow control module of the priming assembly and the manifold.

7. The seed treatment system of claim 1, wherein the priming assembly is configured to measure a presence of the seed treatment in a center portion of the supply line.

8. The seed treatment system of claim 1, wherein the seed treater includes a seed metering chamber and an application chamber disposed generally below the seed metering chamber, wherein the seed metering chamber is configured to deliver an amount of seeds to the application chamber, and wherein the application chamber is configured to apply the seed treatment from the keg assembly to the seeds.

9. The seed treatment system of claim 8, further comprising at least one load cell configured to determine a weight of the seeds delivered from the seed metering chamber to the application chamber.

10. The seed treatment system of claim 8, wherein the seed metering chamber includes a seed wheel defining multiple pockets configured to deliver the amount of seeds to the application chamber.

11. A seed treatment system for use in treating seeds with one or more treatment(s), the seed treatment system comprising:
a keg assembly including a seed treatment;
an application chamber in fluid communication with the keg assembly, the application chamber configured to apply the seed treatment to seeds; and
a seed metering chamber configured to deliver an amount of the seeds to the application chamber based at least in part on a weight of the seeds received in the seed metering chamber.

12. The seed treatment system of claim 11, further comprising at least one load cell configured to determine the weight of the seeds received in the seed metering chamber.

13. The seed treatment system of claim 11, wherein the seed metering chamber includes a seed wheel defining multiple pockets configured to deliver the amount of seeds to the application chamber.

14. A seed treatment system for use in treating seeds with one or more treatment(s), the seed treatment system comprising:
a keg assembly including a seed treatment;
a seed treater in fluid communication with the keg assembly via a supply line, the seed treater including an application chamber configured to receive the seed treatment from the keg assembly via the supply line and apply the seed treatment to seeds;
a priming assembly coupled to the supply line, the priming assembly configured to automatically prime the supply line with the seed treatment; and
a seed metering chamber configured to deliver an amount of the seeds to the application chamber based at least in part on a weight of the seeds received in the seed metering chamber.

15. The seed treatment system of claim 14, further comprising a computing device configured to adjust a flow rate of the seed treatment from the keg assembly based on the amount of seeds delivered from the seed metering chamber to the application chamber.

16. The seed treatment system of claim 14, further comprising a computing device configured to adjust the amount of seeds delivered from the seed metering chamber to the application chamber based on a flow rate of the seed treatment from the keg assembly.

17. A method for use in treating seeds with one or more treatment(s), the method comprising:
delivering, by a keg assembly, a seed treatment to a supply line extending between the keg assembly and a seed treater;
automatically priming, by a priming assembly coupled to the supply line, the supply line with the seed treatment so that the seed treatment is generally continuously available in the supply line;
receiving, at the seed treater, the seed treatment via the supply line; and
applying, by the seed treater, the seed treatment to seeds in the seed treater.

18. The method of claim 17, further comprising receiving an amount of seeds at the seed treater; and
wherein delivering the seed treatment to the supply line includes adjusting, by a computing device, a flow rate of the seed treatment delivered from the keg assembly to the supply line based on the amount of seeds received at the seed treater.

19. The method of claim 17, further comprising adjusting an amount of seeds delivered to the seed treater based on a flow rate of the seed treatment from the keg assembly.
